(19) United States
(12) Patent Application Publication
(10) Pub. No.: US 2019/0084807 A1
(43) Pub. Date: Mar. 21, 2019

(54) CONVEYOR CONTROL DEVICE

(71) Applicant: KERETT ELECTRONIC SERVICES LTD., Gravesend, Kent (GB)

(72) Inventor: Stephen Nelson, Rochester, Kent (GB)

(21) Appl. No.: 16/304,275

(22) PCT Filed: May 24, 2017
(86) PCT No.: PCT/GB2017/051450

§ 371 Date: Nov. 24, 2018

(30) Foreign Application Priority Data
May 26, 2016 (GB) 1609324.7

(51) Int. Cl. B66B 25/00; B66B 27/00; B66B 23/02; B66B 29/00; B65G 43/00

(52) U.S. Cl. CPC B66B 25/00; B66B 25/003; B66B 27/00; B66B 21/025; B66B 23/02; B66B 29/00; B65G 43/00; B66B 25/006

(57) ABSTRACT

A control device adapted to be connected to a conveyor system having a drive motor, a motor control unit which provides a motor control signal to the drive motor and a motor speed sensor adapted to output a motor speed signal to the motor control unit. The control device comprises: a motor speed alteration unit adapted to intercept the motor control signal and to provide a modified motor control signal to the drive motor so as to cause the motor speed to increase or decrease by a speed change value from a first motor operating speed to a target motor operating speed; and a feedback unit adapted to intercept the motor speed signal and to provide a scaled motor speed signal to the motor control unit based on the intercepted motor speed signal, the scaled motor speed signal indicating to the motor control unit that the motor speed has not been increased or decreased from the first motor operating speed by the speed change value.

### FIELD OF THE INVENTION

The invention relates to the field of conveyor control devices, which are adapted to be connected to conveyor systems having a drive motor, a motor control unit and a motor speed sensor.

### BACKGROUND OF THE INVENTION

Conveyor systems are a commonplace feature used in numerous guises across various industries and in many buildings and processes. Conventional conveyor systems are typically belt-driven motorised systems and they are typically used for conveying people and for materials from a first location to a second location, for example as conveyor belts in supermarkets or moving walkways (including escalators and travelators).

Moving walkway systems include a continuous looping stairway (e.g. escalators) or walkway (travelators). These have been developed to transport persons or materials in a fast and efficient way across a relatively short distance (often an incline or decline) and are often found in buildings and venues to provide a fast-throughput alternative to lifts, stairs or walking. An example of a conventional moving walkway system would be an escalator. These systems function by driving a number of adjacent steps around a continuous loop. Each step is secured at its base to a chain or multiple chains, which form the continuous loop. The chains are wrapped around gears sprockets located at the two ends of the escalator. The gears sprockets are driven by a motor, which causes the chains to rotate about the gears sprockets and the steps to traverse the loop. There may also be a moving handrail mechanically associated with the gears. Systems such as these are commonly found in underground or subway systems and allow a person or material to be traversed both horizontally and vertically. A travelator functions in a similar fashion to an escalator but generally without the vertical displacement. In this case, the gears and the steps are configured to provide a horizontal displacement.

Alternatively, conveyor systems may simply have a conveyor belt as its outer surface, the belt being wrapped around two rollers or gears and being driven by a motor. Usually, a system such as this will be used for the movement of materials, for example in a factory or a supermarket. An alternative conveyor system may include a surface comprised of a number of rollers, the rollers being driven by a belt.

Conveyor systems can require substantial investment and have high costs associated with them. Operators and manufactures are therefore constantly searching for ways to reduce operating and maintenance costs (for example, escalator systems). One problem is the repeated turning on and off of a motor, which damages the motor and ultimately reduce reduces the life of the motor. The damage is typically due to the increased stress when accelerating the system from zero to full speed. The application of power causes sudden acceleration and stresses the moving parts, in particular, the bearings and chains.

Furthermore, if a conveyor such as an escalator was stationary, a potential user may assume that the area to which the escalator is leading is closed or the escalator is out of operation. Thus, the potential user may be dissuaded from using the conveyor or may not visit the area to which the escalator leads. As a result, conveyors are often left to run continuously, despite there being periods where people may not be using escalators, for example when the venue is closed or when it is not a peak period. Even if an escalator is turned off when it is not required for long periods of time, there may still be numerous shorter periods of time during its operational period where there is no requirement for the escalator to be operating. Thus, energy is wasted so as to prevent further maintenance costs.

While leaving a motor running may prolong its life, the continuous running of a conveyor system can incur significant running costs and increase wear and tear of the other escalator components. Therefore, to reduce these costs while still avoiding motor damage, new installations of conveyor belts will often have features included whereby the speed of the conveyor can be reduced when full speed is not required. For example, an escalator may have a sensor that detects whether a user is on the escalator. When the escalator is empty, the escalator may slow to a reduced speed.

Some systems have been developed to overcome these issues. However, conventional conveyor systems often utilise complex conveyor control and monitoring systems. These are included to help reduce damage and costs that would result from any failure of the conveyor or motor and to reduce the risk of damage to the goods or persons they are conveying. These systems therefore cannot easily be modified and the removal or disabling of these systems can render the system unsafe and cause the operator problems with maintenance, liability and insurance and be a difficult and expensive process. Accordingly, manufacturers have begun to introducing introduce the speed reducing features as part of new conveyor systems, rather than being an upgrade to existing ones.

### SUMMARY OF THE INVENTION

According to the invention, there is provided an apparatus and method as defined in the independent claims.

A first aspect of the invention provides a control device adapted to be connected to a conveyor system having a drive motor, a motor control unit which provides a motor control signal to the drive motor and a motor speed sensor adapted to output a motor speed signal to the motor control unit, the control device comprising a motor speed alteration unit adapted to intercept the motor control signal and to provide a modified motor control signal to the drive motor so as to cause the motor speed to increase or decrease by a speed change value from a first motor operating speed to a target motor operating speed and a feedback unit adapted to intercept the motor speed signal and to provide a scaled motor speed signal to the motor control unit based on the intercepted motor speed signal, the scaled motor speed signal indicating to the motor control unit that the motor speed has not been increased or decreased from the first motor operating speed by the speed change value.

A conveyor system means any system for the conveying of goods or material from a first position to a second position including a system having a motor driven belt for driving the conveyor. In particular, a conveyor system may include a moving walkway such as an escalator or a travelator.

The invention in this aspect provides a control device for connection to a conventional conveyor system that enables the speed of the motor to be varied by a speed change value so as to reduce power consumption during periods where the conveyor is not required to function at full speed while avoiding turning the motor off and on repeatedly and without the motor speed sensor being aware that the speed of the motor has been changed by said adjustment factor. This allows any monitoring systems designed to detect a change in speed to be circumvented but while still being operational.

The ability to adjust the speed of the motor provides means for reducing energy consumption, for example by reducing the speed of the motor when operation of the conveyor at full speed is not required. This has the additional advantage of enabling this to occur with a high degree of frequency as the speed can easily be reduced, without causing damage to the system through the repeated turning off and starting up of the motor. Thus, energy consumption and therefore running costs can be reduced.

The ability to adjust the speed of the motor also allows for the speed of a fixed speed conveyor to be increased. Accordingly, a fixed speed conveyor can be modified to have multiple speed settings. This provides additional functionality that can be retrospectively installed in an existing conveyor system without significant modification.

Embodiments of the invention in this aspect enable the straightforward and easy installation of the control device into an existing conveyor system as the device is located between the motor control unit and the drive motor and motor speed sensor, and thus does not need to be installed in the motor control unit nor require modification of the motor control unit.

The invention in this aspect also enables the control device to be fitted to an existing conveyor system without having to disable or override safety features designed to detect any changes in the speed of the motor. It further enables the utilisation of these safety limits to monitor motor performance even at motor speeds significantly different to those at which the limits are set. This can be done by using the speed change value to scale the speed signal. This can also be used to tighten or loosen the limits of the safety operating or tolerance range, depending on the requirements of the system.

In this aspect, the speed of the motor may be decreased to 70% of the normal operating speed of the motor (corresponding to a speed change value of 1.43), or to 50% (corresponding to a speed change value of 2) of the normal operating speed. Preferably the motor speed will be decreased to 35%, 30%, 25%, 20%, 15%, 10%, 5% or 1% (corresponding to speed change values of 2.86, 3.33, 4, 5, 6.67, 10, 20 and 100 respectively) of the normal operating speed. The speed of the motor may be increased by 1%, 2%, 5%, 10%, 15%, 20%, 25%, 30%, 35%, 50% or 70% (corresponding to speed change values of 1.01, 1.02, 1.05, 1.1, 1.15, 1.2, 1.25, 1.3, 1.35, 1.5 and 1.70 respectively) of the normal operating speed, or higher.

In an embodiment, the scaled motor speed signal is based on the intercepted motor speed signal and an adjustment factor, wherein the adjustment factor is based on the ratio of the first motor operating speed to the target motor operating speed. Thus, the scaled signal is scaled by a value based on the ratio of the speed at which the motor control unit believes the motor is running at and the speed at which the motor is actually running at. By basing the adjustment factor on this value, the motor speed signal can be adjusted to indicate to the motor control unit that no change in motor speed has occurred, without having to disable the safety system. Moreover, should there be problems with the motor, such as slippage, or the motor is underperforming, the scaled motor speed will still fall outside the speed tolerances as the signal is an accurate representation of the motor's performance (e.g. a reduction from a motor operating at 45 Hz to 4.5 Hz means there is an adjustment factor of 10. If the signal is scaled up by the adjustment factor the scaled signal will indicate a motor frequency of 45 Hz. If the power supply is a 50 Hz supply that should be running at full power and the lower tolerance limit is 48 Hz, then the system will still generate a warning). Thus, the safety systems are functioning and are able to operate normally even at the adjusted speeds and the existing control panel monitoring system is now unaware of the desired change in speed, while still being able to detect undesired or uncontrolled speed changes.

In another embodiment, the adjustment factor may be further based on a compensation factor. The compensation factor can be any value that is used to adjust the adjustment ratio. For example, the compensation factor may be a value that is used to compensate for increased motor slippage at lower speeds, for example as a result of reduced power to overcome friction. In this case, the compensation factor would allow the motor a wider tolerance range before a warning is raised or the motor is disabled. For example, if the existing tolerance limits (i.e. the limits at which a warning would be activated if the motor speed exceeded these limits) of the motor speed were 95% to 105% of the normal operating speed and the speed was adjusted to 10% of the normal operating speed while the scaled signal was scaled upwards by 10 times (i.e. the same factor as the reduction in speed), this would result in a new effective tolerance range of 9.5% to 10.5% of the normal operating speed. If in fact at this speed a tolerance range of 9% to 11% of the normal operating speed was acceptable, the scaled signal could instead be scaled by an adjustment factor of 10.56 if the speed was below the target operating speed, and scaled by an adjustment factor of 9.54 if the speed was above the target operating speed. This modification would increase the tolerance range to 9% to 11% the normal operating speed (90% to 110% of the lower operating speed). The compensation factor, as was the case in the example, may be directly linked to the speed of the motor or may alternatively be a set value across the entire range or a value depending on the extent of the speed change. For example, the compensation factor may be 1.01, 1.02, 1.05, 1.1, 1.15, 1.2, 1.25, 1.3, 1.35, 1.5 or 1.70. For example, if the motor is adjusted to 10% of the normal operating speed but the motor runs at 8% due to a reduction in torque, the adjustment factor may be multiplied by 1.25 to give an adjustment factor of 12.5 instead of the 10 if the adjustment factor is simply the speed change value.

In another embodiment, the control device may further comprise a sensor or a timer. This may allow the change in speed to be controlled by a stimulus, such as a user entering or leaving a conveyor, a set time period (e.g. when the conveyor is not in use) or a combination of these features, for example. Thus, the change in speed can be controlled based on the requirements of the conveyor. This allows the conveyor to slow during “off-peak” periods, for example when no users are present, or haven't been present for five minutes or to speed up when required. It also enables the conveyor to slow down more frequently than would otherwise be possible without damage if the conveyor was repeatedly turned off and on. Moreover, the conveyor can do this without the continual input of an operator.

In another embodiment, the control device may be adapted to be retrospectively connected to a conveyor system. As the control device is adapted to intercept the motor control signal and the motor speed signal, it can be located between the control panel of the conveyor system, which houses the motor control unit, and the motor and the motor speed sensor. This enables the control device to easily be installed without modifying the control panel. As it is adapted to be retrospectively fitted, the control device can easily be inserted at this point, usually requiring the severing of the motor supply cable and the speed sensor cable. By enabling the control device to be retrospectively installed, existing conveyor systems that do not have variable speed settings can be updated without the significant expenditure required for a new conveyor installation or without the major rework to the control panel and disabling of the safety systems associated with existing retrofit devices.

In a second aspect of the invention, a method for controlling a conveyor system is provided, the system having a drive motor, a motor speed sensor adapted to output a motor speed signal to a motor control unit, which provides a motor control signal to the drive motor, wherein the method comprising intercepting the motor control signal, outputting a modified motor control signal so as to cause the motor speed to increase or decrease, intercepting a motor speed signal and outputting a scaled motor speed signal. In this aspect, the motor control signal is adjusted by a speed change value to obtain the modified motor control signal and the motor speed signal is adjusted by an adjustment factor to indicate to the motor control unit that the motor speed has not been increased or decreased from the first motor operating speed by the speed change value.

### BRIEF DESCRIPTION OF THE DRAWINGS

Specific embodiments of the invention will now be discussed in detail with reference to the accompanying drawings, in which:

FIG. 1 shows a typical conveyor control system.

FIG. 2 shows a conveyor system comprising a variable speed control device.

FIG. 3 shows a conveyor system comprising a variable speed control device.

FIG. 4 shows an embodiment of the present invention;

FIG. 5 show a modification to the embodiment of FIG. 4.

### DETAILED DESCRIPTION

A device is provided for installation into a motorised conveyor system. The motorised conveyor system has a motor, which directly or indirectly drives a conveyor. The motor is controlled by a motor control unit, which provides a motor control signal to the drive motor, indicating the speed and direction of the motor. The speed at which the motor is running is detected by a motor speed sensor, which provides feedback on the speed of the motor to the motor control unit in the form of a motor speed signal. The device of the present invention is installed into the system between the motor control unit and the motor and the motor control unit and the motor speed sensor. The device comprises two functions or units, a motor speed alteration unit or variable speed device and a feedback unit. However, these may be a single device or component that carries out the two functions. The motor speed alteration unit is able to intercept the motor control signal from the motor control unit and modify the signal or output a different motor controlled signal so that the motor changes speed compared to the operation of the motor under the unmodified motor control signal. The ratio of the normal operating speed to the target operating speed is the speed change value. The feedback unit intercepts the motor speed signal from the conveyor's speed sensor to stop the signal indicating to the control unit that the speed of the conveyor has been changed by the speed change value.

The feedback unit therefore scales the motor speed feedback signal by a value based on the ratio of the motor control signal from the control panel and the motor speed signal output to the motor.

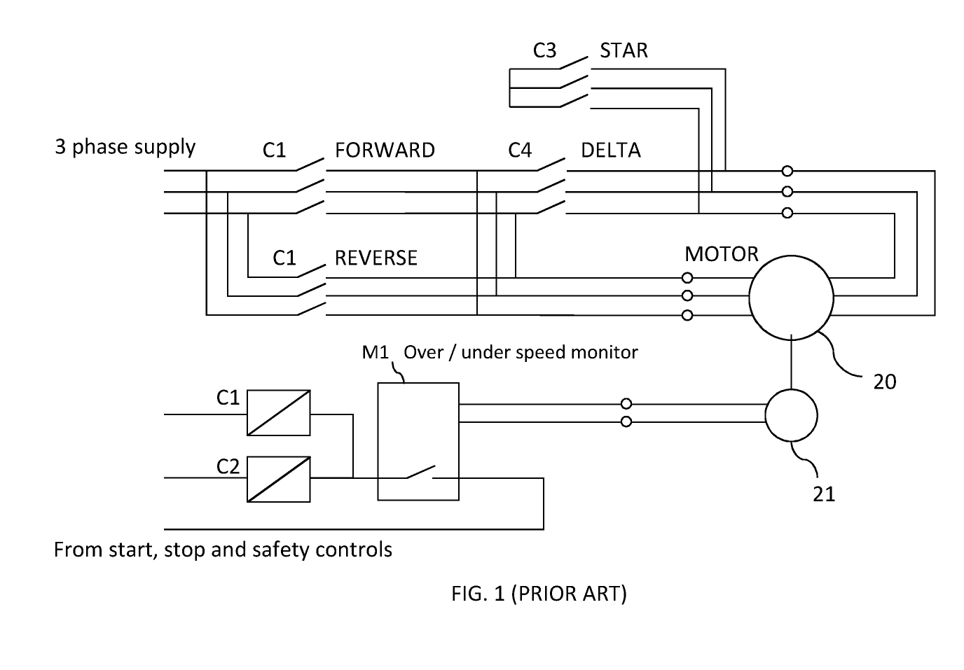

FIG. 1 shows a conventional conveyor control circuit 10. The circuit 10 comprises a drive motor 20 for driving a conveyor. The drive motor 20 will drive a band or a chain (not shown), which forms a continuous loop around at least two gears, The band itself may form the conveyor surface or there may be, for example, a number of steps or rollers attached to the band or chain, the steps or rollers forming a conveying surface. The circuit 10 is powered by three phase power supply 11 and the drive motor 20 is connected using conventional star/delta contactors C3, C4 along with reversing contactors C1,C2. The power supply 11 is of fixed voltage and frequency as determined by the power generation utility.

The use of contactors C1,C2,C3,C4 is well known in the conveyor industry. Contactors C1 and C2 reverse two of the phases to effect reversing. Contactors C3 and C4 connect the motor windings in STAR configuration for starting and DELTA configuration for normal running. The STAR connection provides high starting torque. Once running, the contactors switch over to reconfigure the motor to DELTA configuration for high efficiency. The changeover is effected by timers (not shown). The STAR/DELTA system comprises a series of latching circuits.

The speed of the motor 20 is monitored during operation by a sensor 21 and a speed monitoring device M1, which forms part of the control unit. In modern systems, the sensor 21 typically consists of a proximity sensor that detects a series of holes or projections in a wheel fixed to the motor shaft, which then outputs a digital signal to the speed monitoring device M1. Alternatively, as is common in older devices, the sensor 21 is a tacho generator connected to the drive motor 20 and the voltage generated by the tacho generator is measured by the speed monitoring device M1.

The control unit, including the speed monitoring device M1, ensures that the speed of the motor 20 is within a predetermined tolerance. This allows the control unit to monitor the performance of the drive motor 20. For example, should the speed of the motor 20 fall below 95% or above 105% of a target speed, the control unit will warn the operator and/or turn off the motor. Typical means of turning off the motor include interrupting the STAR/DELTA latching circuit and/or the reversing contactor C1,C2 latching circuits. These safety systems are a common feature in conveyor systems. In particular, features like this will be found in control circuits for moving walkways as these are often in public places and therefore are subject to requirements and insurance terms.

A conveyor system employing the control circuit 10 of FIG. 1 is typical of conventional conveyor systems. As these systems have one fixed speed they are either left on during periods when they are not required or not in use so as to preserve the life of the motor, or they are turned off to reduce energy consumption. As discussed above, the repeated turning off and on can damage the motor 20 and the attached mechanisms. This is a particular problem where the conveying system is a large system such as an escalator, as the energy cost of continuous running is high and the parts of the motor are expensive to replace.

To overcome this problem, conveyor manufacturers (in particular, escalator manufacturers) have designed new systems that include multiple motor speed settings based on criteria such as if the conveyor is in use, if there have been extended periods of inactivity and/or particular times such as those when the conveyor is known not to be in use. Accordingly, when the conveyor is not required, for example when the building it is located in is closed, the motor (and thus the conveyor) slows from a higher, normal operating speed to a lower, idling speed. For example, the frequency of the motor drops from 50 Hz to 5 Hz. This significantly reduces the energy consumed while still avoiding damage to the motor resulting from turning the motor on and off. This has a particular advantage in situations where the conveyor regularly has periods of time where it isn't being used as the new systems enable the idling or lower speed to be engaged more often. For example, if the system was used in a moving walkway, such as an escalator, and was programmed to idle (i.e. switch to the lower speed) after a set period of time of no users being present on the escalator, for example 10 minutes, the control system for the escalator would switch the escalator down to the lower/idling speed (e.g. to 10% of the original speed). This would save significant amounts of energy while still avoiding the damage associated with turning the motor on and off repeatedly and as it avoids the damage, the speed change can occur frequently without the risk of damage to the motor.

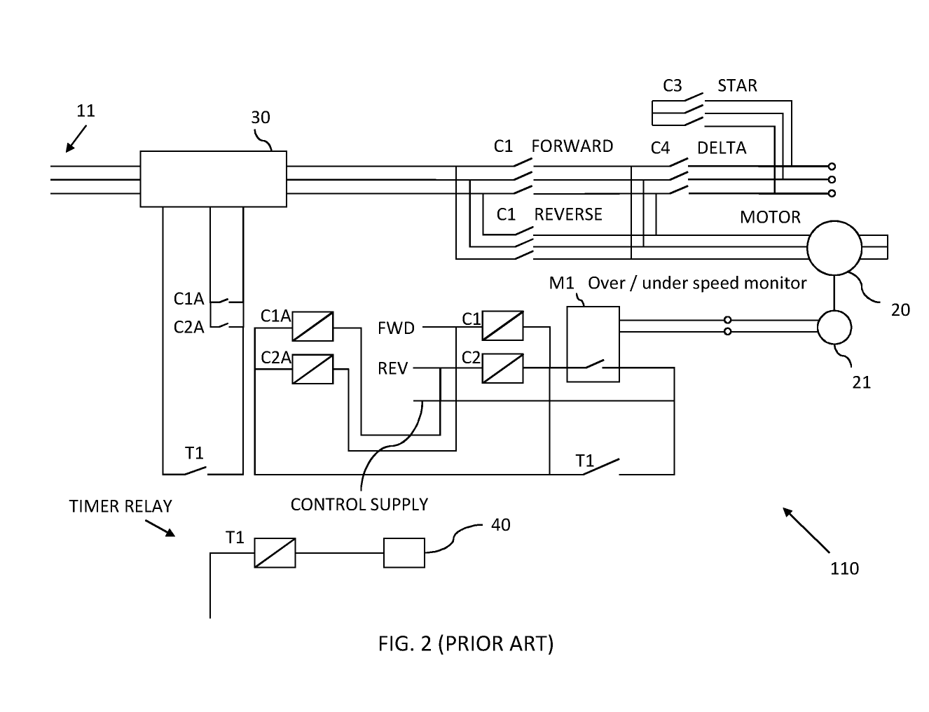

FIG. 2 shows a conveyor control circuit 110 having the ability to vary motor speed, as described above. For example, circuit 110 is representative of a typical installation in modern escalators.

Alternatively, elements of circuit 110 can be retrospectively fitted into an existing escalator system, including one having the conveyor control circuit 10, to form circuit 110. However, installation requires significant modification of the control panel including accessing the signals for motor direction, brake activation, speed monitoring bypass and the three phase power for the variable drive.

As with circuit 10, circuit 110 comprises a motor 20, a three phase power supply 11, a speed monitor M1 and sensor 21, with the drive motor 20 being connected using conventional star/delta contactors C3, C4 along with reversing contactors C1,C2. In circuit 110, the motor speed can be controlled using a variable speed drive 30. The variable speed drive 30 is located between the power supply and the forward and reverse contactors C1, C2. Thus, the variable speed drive is used in a single direction mode with the original contactors reversing the phases to effect motor direction control. Circuit 110 further includes a sensor 40 connected to a timer relay T1. The sensor 40 can be, for example, optical through beams, radar or any form of motion detector or passenger/goods sensor/detector.

The use of a sensor 40 and the timer relay T1 allows the circuit 110 to control the speed of the conveyor in response to certain stimuli or at set intervals. In one example, sensor 40 is a through beam that detects whether a user is on an escalator. The sensor 40 is located at the start of an escalator and sends a detection signal to the timer relay T1 when a person embarks the escalator and breaks the beam of sensor 40. Timer relay T1 is adapted to (in this example) add a ten minute delay to the detection signal (e.g. timer relay T1 receives the signal and begins a ten minute timer) and therefore, after a ten minute delay, sends a detection signal to the circuit control unit.

The timer T1 of circuit 110 functions using two sets of contacts. The first connects to the Hi/Lo speed input of the variable speed drive 30. When idling, the drive 30 is in the slow speed mode and moves to (normal) high speed when the contacts are closed (i.e. during the active time of the timer relay T1). The second set of contacts overrides the output of the monitoring circuit M1 and prevents C1 and C2 from disabling the motor 20. The contacts of the speed monitor M1 are closed during when the motor 20 is operating at the normal speed and are open when the speed is set to a value outside these limits. In circuit 110, the speed monitor M1 is typically a latching arrangement. Thus, if the monitor M1 is tripped by the speed being detected outside of the predetermined range, it must be reset.

Once the timer T1 has sent a detection signal to the circuit control unit, the circuit control unit sends a motor control signal to the variable speed device 30, which causes the motor 20 to slow down to an idling speed. Typically, the variable speed device 30 will use a ramping program to slow the motor to avoid damage.

However, as with circuit 10, the control unit of circuit 110 has features to monitor the speed of the motor and to alert an operator or disable the conveyor in the event of deviations from a target speed range. In order to vary the speed, circuit 110 has a mechanism by which it overrides the safety features to avoid the speed monitor M1 sending a signal to the control unit and disabling the motor 20 or outputting a warning signal. The mechanism of circuit 110 effectively disables or bypasses the speed monitor M1 when the speed is set to any value other than the normal speed by means of contacts on the timer relay T1 bypassing the speed monitoring device M1 whenever the motor speed is operating at a speed other than normal.

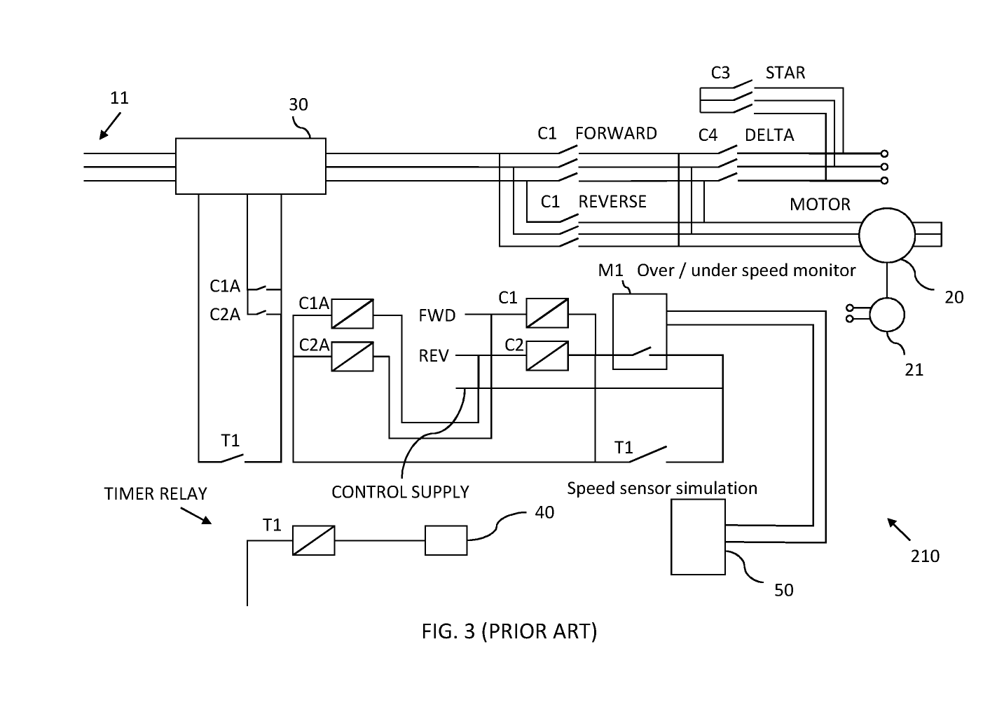

FIG. 3 shows an example circuit 210. As with the circuits 10,110 of FIGS. 1 and 2, circuit 210 comprises a motor 20, a three phase power supply 11, a speed monitor M1 and sensor 21, with the drive motor 20 being connected using conventional star/delta contactors C3, C4 along with reversing contactors C1,C2. Circuit 210 also has the ability to control the speed of the motor via a variable speed drive 30 located between the power source 11 and the reversing contactors C1, C2 based on an input from a sensor 40 and a timer relay T1. However, as with circuit 110, there are safety controls and a speed monitor M1 to monitor the speed (and thus performance) of the conveyor and whether the speed of motor 20 falls outside a predetermined range.

In the circuit 210, a speed sensor simulator 50 is used to satisfy the speed monitor M1. In circuit 210, either the speed sensor 21 is disconnected from the circuit (for example, if the ability to vary speed has been retrospectively fitted or the circuit is a mass-produced circuit manufactured to be used in multiple systems) or there is no speed sensor 21. The speed sensor simulator 50 is then connected to the speed monitor M1 and sends a signal to the speed monitor M1 to satisfy the speed monitor M1 that the speed of the motor 20 is within the predetermined safe operating range. As the speed monitor M1 is not connected to a speed sensor 21, the speed sensor simulator 50 is operational regardless of the speed of the motor 20 and simulates a single speed within the predetermined safe range. However, this can pose a substantial safety risk as the safety features of the conveyor are essentially disabled and the operator has no means by which to monitor the speed of the motor 20. Moreover, as with circuit 110, installation of the variable speed system in circuit 210 requires significant modification to the circuitry and control panel of the conveyor control system.

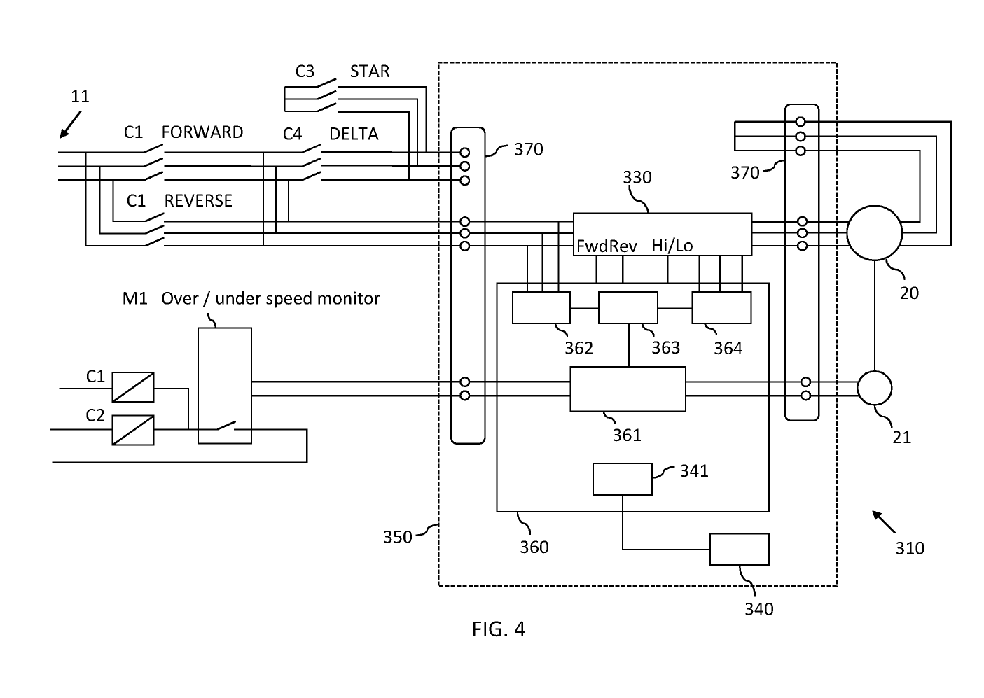

FIG. 4 shows an embodiment of the invention. The circuit 310 of FIG. 4 is a conveyor control system comprising a power supply 11 delivering a three phase power supply to the circuit 310, reversing contactors C1, C2, star and delta start-up contactors C3, C4. The circuit 310 includes a motor 20, which is driven by the circuit and in turn drives a conveyor (not shown). The speed at which the motor 20 is running is monitored by a speed sensor 21 and a speed monitoring device M1. In this embodiment, the speed sensor 21 is a proximity sensor which detects a series of holes or projections in a wheel in the motor as the wheel turns. The proximity sensor outputs a digital signal based on the speed at which the wheel is turning (and hence the speed at which the motor 20 is running) to the speed monitoring device M1. In an alternative embodiment, the sensor 21 is a tacho generator connected to the drive motor 20 and the voltage generated by the tacho generator is measured by the speed monitoring device M1.

The circuit 310 also includes a speed control system 350, 340 comprising a variable speed device 330, a measurement and feedback device 360 and a sensor 340. In this embodiment, the variable speed device 330 is a variable frequency device, which acts as an electronic gearbox. The variable speed device 330 and the measurement and feedback device 360 can be installed into the system as a single device or box 350, with the sensor 340 being attached near to the conveyor and connected to the measurement and feedback device 360. The single device or box 350 can be retrospectively installed into an existing conveyor circuit, such as the circuit 10 of FIG. 1. In circuit 310, the box is located between the reversing and star/delta contactors C1,C2,C3,C4 and the motor 20 and between the speed monitor M1 and the speed sensor 21. This is significantly easier to install and retrofit than the speed variation devices of FIGS. 2 and 3 as a cable from the control panel, which would typically contain the contactors C1, C2, C3, C4, the speed monitor M1 and other components, can simply be cut and the box be connected to the one cable. In contrast, earlier installations of devices that are capable of varying the speed of conveyors, such as the components of circuits 110 and 210, require significant modification to the control panel to access the signals for motor direction, brake activation, speed monitoring bypass and the three phase power for the variable drive. Thus, the present invention provides a system 350 for varying conveyor speed in response to stimuli or certain criteria that can easily be installed into an existing conveyor system with no requirement for reconfiguration or the major re-work of a control box. This is possible as the star and delta start-up contactors C1, C2 will not be required as a variable speed drive 330 can perform their function. The connections from the device 350 to the motor 20 will typically be connected in delta. Both the measurement and feedback device 360 and the variable frequency drive 330 receive power from the three phase power supply 11 and the measurement and feedback device 360 controls the variable frequency drive 330. There may be a processor (not shown) in the measurement and feedback device 360 that controls the operation of the device 350.

In this embodiment, speed of a conveyor can be controlled such that when the conveyor is not being used or during periods when full speed is not required, the speed of the motor 20 can be slowed to a lower speed. For example, the speed may be 10% of the conveyors normal operating speed (corresponding to a speed change value of 10). This enables the reduction of power consumption that is associated with the higher operating speed while avoiding the shutdown of the motor 20, which might otherwise result in damage to the motor 20.

In this embodiment, the sensor 340 is a through beam. In alternative embodiments, sensor 340 is a radar motion detector, a motion detector or any other movement detecting mechanism. The through beam sensor 340 detects whether a user or an object is on the conveyor and sends a signal to the timer relay 341. The timer relay 341 may have a time delay programmed such that the signal from the sensor 340 does not cause a change in speed until a predetermined period has elapsed. For example, the time relay 341 may instigate a ten minute delay to ensure the speed of the conveyor is not changed prematurely when it is likely to be needed or when changing between speeds too frequently may mitigate savings in energy through inconvenience or the energy required to increase the speed again. The timer relay 341 then causes the speed of the variable frequency drive 330 to change.

The variable frequency drive 330 will then control the drive motor 20 causing it to either increase speed or decrease speed (via the Hi/lo input), depending on the signal from the sensor 340 and timer relay 341. In this embodiment, increases and decreases in speed are carried out using a ramping profile controlled by the variable frequency drive 330. The ramping profile can be any incremental increase in speed so as to prevent damage the motor and avoid sudden, potentially dangerous, changes in conveyor speed.

In another embodiment, the sensor 340 can be used in conjunction with a speed ramping profile to provide a warning system. For example, in the case of an escalator that is moving towards the upper level (e.g. it conveys passengers to a higher position), the escalator has an entry sensor at the top of the escalator and at the bottom of the escalator. If a passenger enters the escalator at the lower position, the sensor 340 will detect the user and the conveyor speed will increase at a normal pace, using the standard ramping profile. However, if a passenger tries to board the escalator at the top of the escalator (i.e. at the wrong end) the sensor 340 will detect the user and the motor 20 speed will increase at a much faster pace as the ramping profile is different. Thus, the very quick change in pace of the conveyor informs the user that they are attempting to board the escalator at the wrong end and dissuades the user from boarding the conveyor.

In another embodiment, a hand-rail monitor unit may be provided to monitor movement of a handrail of a conveyor system. Based on the monitored movement of the handrail, the operating speed of the conveyor system may be adapted so that, for example, if it is detected that the handrail has stopped moving while the conveyor has not stopped moving, the conveyor may be shut-down. This may be done via the feedback device 360 which controls operation in accordance with a signal from the hand-rail monitor unit. In other words, the feedback device 360 may be adapted to receive one or more further monitoring signals and, depending on the one or more further monitoring signals, the feedback device 360 may adapt its output to alter operation of the conveyor system. In this way, operating of the feedback device 360 may be altered and/or overridden based on one or monitor signals of the conveyor system.

In alternative embodiments, there may be no timer relay 341 and/or no sensor 340. For example, the circuit may change speed in response to an operator's command or may be linked to a timer only, with no sensor input. In any of the above embodiments, timer relay 341 may have a predetermined time range when the speed of the conveyor is set to be a lower speed. For example, the timer relay 341 may be adapted to cause the motor speed to slow to an idling speed when the conveyor is not required (for example, 11 pm to 6 am). Alternatively, this may be achieved through the use of a processor rather than a timer relay.

As with the circuits 10, 110, 210 of FIGS. 1, 2 and 3, the circuit 310 contains a speed monitoring system comprising a speed sensor 21 and a speed monitoring device M1. These are included in circuit 310 to ensure that any change in motor speed is monitored so that a faulty motor can be repaired and accidents can be avoided. For example, a change in motor speed may be a result of slippage and loss of torque. This is done by monitoring the speed and comparing it to a predetermined range. Should the speed fall outside of the range, an error may be generated and/or the motor 20 turned off. This is particularly important in situations where damage may occur as a result of a faulty conveyor. Moreover, the use of a speed monitoring system 21,M1 is often a requirement in order for an operator to obtain insurance, e.g. public liability insurance. Without adequate monitoring, insurance can be invalid due to the inherent risks of operating a conveyor without being able to monitor its performance.

Therefore, circuit 310 has a feedback system that allows the speed to be changed without having to remove the speed monitoring device M1, change how the control panel deals with the errors, disabling the speed monitoring device M1 (e.g. the example of FIG. 2) or spoof a speed within the predetermined operating range (e.g. the example of FIG. 3). In addition, the feedback system 360 installed in circuit 310 enables the monitoring of the performance of the motor 20 to continue across all speed ranges while requiring minimal modification to the circuit during installation.

The feedback system of circuit 310 detects the frequency either side of the variable frequency device 330. The input frequency to the variable frequency device (Fₓ) is measured on the power supply 11 side of the variable frequency device 330 by measurement device 362 and represents the target motor speed as set by the control panel of the conveyor system. The frequency out (output frequency) of the variable frequency device (F_{y}) is measured on the motor 20 side of the variable frequency device 330 by a second measurement device 364. In an alternative embodiment, the measurements may be taken by a single device. A processor 363 then calculates an adjustment ratio, which is the input frequency divided by the output frequency (Fₓ/F_{y}). In an alternative embodiment, this is simply calculated by the circuitry. The adjustment ratio thus represents the speed change value from the normal speed (i.e. the speed at which the control panel has set the motor to run) to the adjusted speed. As discussed above, the adjustment of the speed of the drive motor 20 will typically take place in using a ramping profile.

It can therefore be appreciated that the adjustment ratio will constantly be changing in response to the changes in the frequency out (F_{y}) value.

The adjustment ratio is then used by a signal multiplier 361 to scale the signal from the speed sensor 21 such that the speed monitoring device M1 is not aware that the speed has been adjusted by the speed change value. In one embodiment the signal is scaled by the adjustment value. Where this is the case, eventually, once the motor speed has reached its target speed, the adjustment value will equal the speed change value. In an alternative embodiment, it is scaled by a value based on the adjustment value and a compensation factor. By scaling the signal by the adjustment value the speed monitor device M1 is satisfied that the speed of motor 20 has not changed and therefore, provided the adjusted speed (motor speed signal) falls within the predetermined operating range, no errors are generated. Moreover, unlike the circuits 110, 210 of FIGS. 2 and 3, the circuit 310 enables the safety systems to accurately function as the scaled value is an accurate representation of motor 20 performance. In other words, because the motor 20 speed is adjusted by an adjustment factor, rather than a simulated value, the value can be used to determine whether the speed of the motor falls within the original range. For example, if the input frequency (Fₓ) 50 Hz and the output frequency (F_{y}) is 5 Hz the adjustment factor (Fₓ/F_{y}) is 10 and therefore, in this embodiment, the motor speed signal is intercepted by the signal multiplier 361 and scaled up by this factor of 10. Thus, if the predetermined operating range is 45 Hz to 55 Hz and the motor is operating at a frequency of 4 Hz, the signal is scaled up to 40 Hz and will still generate a warning and/or shut down the motor. Accordingly, the safety controls are operational and still function as they would if the device 350 was not present. This drastically improves the reliability and lifespan of the conveyor system compared to other variable speed retrofit installations, as maintenance requirements are detected. Moreover, the safety of operators and users is improved as damage and injury is reduced by having a functioning safety system. These in turn reduce the cost of operating conveyor systems. Firstly, there is the dramatic decrease in energy consumption as a result of being able to use an idling speed and to be able to engage this feature, without the risk of motor damage. Secondly, as wear of the motor 20 and other components, such as the gears of the conveyor system, is reduced by the use of a lower speed in off peak periods, maintenance costs are reduced. These costs are further lowered as the ability of the safety system to function allows for the detection of problems with the conveyor system and prevents failure or more costly damage. Being able to detect when there is damage to or a problem with the motor 20, for example slippage, also reduces the risk of damage to the users or products on the conveyor and therefore reduces costs of accidents, losses and damage. The reduced risk and liabilities associated with the system of the present invention enables the operators of conveyors to satisfy insurance companies that may not otherwise be willing to insure a conveyor should the safety system be disabled.

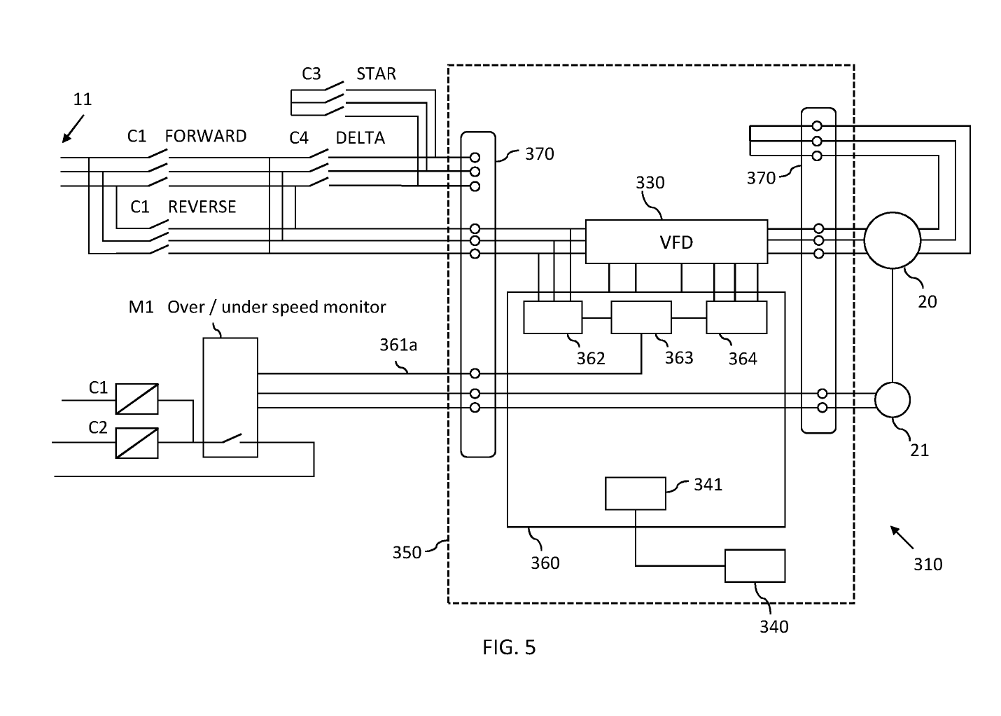

FIG. 5 shows a modification to the embodiment of FIG. 4, wherein the signal multiplier 361 has been omitted such that the adjustment ratio signal is provided from the processor 363 to the over/under speed monitor. In this way, the circuit 310 does not employ a signal multiplier. Rather, scaling or multiplication using the adjustment ratio is implemented by the over/under speed monitor so as to provide a scaled motor speed signal to the motor control unit. It will therefore be understood that other monitoring system may be used or modified in accordance with proposed embodiments.

In another embodiment, the adjustment factor may include a compensation component. The presence of a compensation component, represented by a compensation factor, allows the adjustment factor to take into account any factors that may impact the operation of the motor 20 as a result of the different speeds. For example, the compensation factor may adjust for increased slippage as a result of the lower torque experienced at slower speeds by allowing for a greater tolerance range before the safety system of the conveyor system generates a warning or disables the motor 20. Likewise, it may decrease the tolerance range at a higher speed so as to ensure that the motor 20 is functioning properly at the higher speeds. For example, the compensation factor at a lower speed (e.g. 10% of the normal operating speed) may multiply the ratio of the frequency in/frequency out (Fₓ/F_{y}) by 1.1, 1.05 or 1.01, for example. Thus, the modified adjustment factor would allow for increased slippage at the lower speed by bringing speed values that would otherwise be below the lower threshold (if scaled up without a compensation factor) within the tolerance range. Alternatively, the compensation value may be linked to the speed. In this case, the compensation factor may increase the adjustment factor for speeds below the target speed and may decrease the adjustment factor when the motor is running above the target speed.

In one embodiment, circuit 310 is a moving walkway control system, in particular an escalator (not shown) control system. The motor 20 drives at least two gears in the escalator, the gears being located in different vertically and horizontally planes relative to one another. The gears in turn drive a belt or chain, the belt or chain forming a continuous loop about the gears. Attached to the belt or chain is a number of steps that rotate with the chain or belt. These form the platform on which the user or goods stand. In this embodiment, the circuit 310 controls the escalator motor 20.

The device 350,340 can be installed into any conveyor system through a simple installation process. The control device 350,340 typically is installed as a single unit or control box 350 with a number of ports 370 for attaching the existing wires. Installation is typically possible with the severing of the wire connecting the control panel of the conveyor system to the motor 20 and other components. This can alternatively be done using existing plug connections on the wires from the existing control panel to sockets on the control box 350. In this embodiment, the control box 350 would have additional wires that plug into the components such as the motor 20 and the speed sensor 340. Existing installations, such as those depicted in FIGS. 2 and 3 require that the control panel is disassembled and numerous connections must be made. The control device of this invention does not require access to the control panel and once in place allows the system to be disconnected and removed for service or repair while still leaving the escalator in its original fixed speed configuration.

In this embodiment, the sensor 340 comprises an entry through beam and an exit through beam. The entry through beam detects when a user has entered the escalator. If there is a user on the escalator, the speed of the escalator is at the normal operating speed. The exit through beam then detects when a user exits the escalator and slows the speed to an idling speed, at 15% of the normal operating speed, for example. Alternatively, there may be a delay of ten minutes prior to the change in speed and/or there may only be an entry sensor and after an elapsed period of time since the last entry the escalator will change to a slower speed. In addition to this, the timer relay 341 may also provide a period of time in which the escalator is always in an idling state, for example when the venue housing the escalator is closed.

The signal from the timer relay 341 and/or the sensor 340 triggers a change in speed in the variable frequency drive 330. This in turn reduces the power to the motor 20 using a deceleration ramping profile, which slows the speed of the motor 20. The use of a ramping profile also protects the motor 20 from damage resulting from sudden changes and prevents accidents that may occur as a result of a sudden change in speed of the conveyor. As the speed of the motor 20 slows, the signal from the speed sensor 21 is intercepted by the signal multiplier 361. In this embodiment, the sensor 21 is a proximity sensor. In alternative embodiments, the speed sensor 21 is a tacho-generator, which generates a voltage based on the speed of the motor 20, and the speed multiplier 361 is a variable gain amplifier so that the voltage at lower motor speeds is still within a suitable range for detection. Alternatively, variable frequency, variable amplitude oscillator/invertor can be used to generate re-scaled tacho-generator signals. The scaled speed signals are then transmitted to the speed monitor M1. When the escalator speed is returned to its normal operating speed (i.e. the speed at which the control panel understands the motor 20 to be running at), the signal multiplier 341 is no longer required to scale the speed signal (for example, the scaling factor may be 1).

Given the substantial investment that is associated with the installation and running of an escalator system, there is a huge advantage in being able to upgrade an existing system to increase the life of the escalator components by reducing wear and tear and monitoring system performance while being able to reduce energy consumption without the increased damage associated with turning motors on and off. The control device 350,340 of the present invention also allows for a simple retrospective installation into an existing system, regardless of age and components. This reduces costs and upfront investment in new systems and the removal of systems that may still be in good working condition. It also allows for the maintenance of a safety and monitoring system, which is essential in conveyors where there is a risk of damage or injury if the conveyor malfunctions or cannot maintain its speed. This is reflected in the requirement for many conveyor insurance policies to have functioning safety systems in place. The lack of such a system will often result in use of such a system being prohibited.

Other variations to the disclosed embodiments can be understood and effected by those skilled in the art in practicing the claimed invention, from a study of the drawings, the disclosure, and the appended claims. For example, in the examples above:

The control device may comprise a processor and the functions of the individual components may be carried out by the processor.

The control box is not limited to a box, it may be a circuit board or separate components.

A speed sensor can be a tacho generator, a proximity sensor, a magnetic sensor or any other sensor that can detect the speed of a motor.

A signal multiplier can be any component that can receive or read a first input signal and output a second, different signal, based on said first input. For example, a signal multiplier may be an electronic signal amplifier, an electronic gearbox or a variable frequency, variable amplitude oscillator/inverter.

A sensor can be any means of detecting whether a user or object is present or whether the conveyor must be in operation. For example, a sensor may be a through beam, a motion detector, a radar detector, a manually actuated gate or a pressure sensor.

1. A control device configured to be connected to a conveyor system having a drive motor, a motor control unit which provides a motor control signal to the drive motor and a motor speed sensor configured to output a motor speed signal to the motor control unit, the control device comprising:
a motor speed alteration unit configured to intercept the motor control signal and to provide a modified motor control signal to the drive motor so as to cause the drive motor speed to increase or decrease by a speed change value from a first motor operating speed to a target motor operating speed; and
a feedback unit configured to intercept the motor speed signal and to provide a scaled motor speed signal to the motor control unit based on the intercepted motor speed signal, the scaled motor speed signal indicating to the motor control unit that the drive motor speed has not been increased or decreased from the first motor operating speed by the speed change value.

2. The control device of claim 1, wherein the scaled motor speed signal is based on the intercepted motor speed signal and an adjustment factor, that is based on a ratio of the first motor operating speed to the target motor operating speed.

3. The control device of claim 2, wherein the adjustment factor is further based on a compensation factor.

4. The control device of claim 3, wherein the adjustment factor is further based on a target operating speed.

5. The control device of claim 1, wherein the speed change value for decreasing the drive motor speed is greater than 1.25.

6. The control device of claim 1, wherein the speed change value for increasing the drive motor speed is less than 0.75.

7. The control device of claim 1, the control device further comprises a sensor or a timer.

8. The control device of claim 1, wherein the motor speed alteration unit comprises a variable frequency drive.

9. The control device of claim 1, wherein the feedback unit is further configured to compare the motor speed signal to a predetermined speed tolerance range based on the target motor operating speed and to output a warning signal if the motor speed signal indicates that the drive motor speed is outside the predetermined speed tolerance range and/or disable the drive motor.

10. The control device of claim 1, wherein the conveyor system to which the control device is configured to be connected is a belt driven motorised conveying system.

11. The control device of claim 1, wherein the conveyor system to which the control device is configured to be connected is a moving walkway.

12. The control device of claim 1, wherein the control device is configured to be retrospectively connected to a conveyor system.

13. The control device of claim 1, wherein the drive motor speed is gradually increased or decreased by a value less than the speed change value until the speed reaches the target motor operating speed.

14. The control device of claim 1, wherein the control device at least one additional sensor.

15. The control device of claim 1, further comprising a direction sensor configured to detect a direction at which a user or object is alighting the conveyor relative to a conveying direction of the conveyor; and
wherein the control device is configured to generate a warning signal if the direction sensor detects that the user or object is alighting the conveyor in a direction that is opposite to the conveying direction of the conveyor.

16. The control device of claim 1, further comprising a hand-rail monitor unit configured to monitor movement of a handrail of the conveyor system;
wherein if the hand-rail monitor unit identifies that the movement of the handrail does not meet a predetermined requirement, the hand-rail monitor unit is configured to communicate an error signal to the feedback unit; and
wherein the feedback unit is further configured to modify the scaled motor speed signal based on an error signal received from the feedback unit.

17. A method for controlling a conveyor system having a drive motor, and a motor speed sensor configured to output a motor speed signal to a motor control unit, which provides a motor control signal to the drive motor, the method comprising:
intercepting the motor control signal;
outputting a modified motor control signal so as to cause the drive motor speed to increase or decrease from a first motor operating speed to the target motor operating speed;
intercepting a motor speed signal; and
outputting a scaled motor speed signal;
wherein the motor control signal is adjusted by a speed change value to obtain the modified motor control signal; and
wherein the motor speed signal is adjusted to indicate to the motor control unit that the drive motor speed has not been increased or decreased from the first motor operating speed by the speed change value.

18. The method of claim 17, wherein the motor speed signal is adjusted by an adjustment factor that is based on a ratio of the first motor operating speed to the target motor operating speed.
